(19) United States
(12) Patent Application Publication
(10) Pub. No.: US 2005/0232075 A1
(43) Pub. Date: Oct. 20, 2005

(54) Feed preparation device & method of use thereof

(76) Inventor: Pauline Kistela, Lloyd Harbor, NY (US)

Correspondence Address: LILLIE LAW, LLC, 269 SOUTHPORT ST, RONKONKOMA, NY, 11779, US

(21) Appl. No.: 11/108,043

(22) Filed: Apr. 15, 2005

Related U.S. Application Data
(60) Provisional application No. 60/562,285, filed on Apr. 15, 2004.

(51) Int. Cl. B01F 1/00

(52) U.S. Cl. 366/279

(57) ABSTRACT

A feed preparation device comprising a plurality of containers, each container having shape comprising a wall and a base cooperatively connected thereto, each container being configured and dimensioned to be at least partially insertable together; wherein a first container having at least one opening therein, wherein the location of said at least one opening is positioned in a location selected from the group consisting of: a wall, and a base; and a second container having means for receiving and positioning said first container in a plurality of positions; said second container being configured and dimensioned to hold a liquid substantially comprised of water.

### CROSS REFERENCES TO RELATED APPLICATION(S)

This application is entitled to the benefit of U.S. Provisional Patent Application having Ser. No. 60/562,285 filed 15 Apr. 2004, entitled “Health-E-Hay Soak & Strain Bucket.”

### BACKGROUND OF THE INVENTION

This invention relates to a device that provides improved hygiene in the preparation of animal feed, particularly, a device that provides improved hygiene in the preparation of feed for horses, and most particularly, a device that provides improved hygiene in the preparation of hay for horses.

Historically, for various reasons set forth hereinbelow, some horses have contracted chronic obstructive pulmonary disease (hereafter COPD), which is a non-contagious condition wherein long term chronic inflammation of the air passages occur. COPD also tends to be cyclic in its prevalence, as it is often associated with allergies, dusty and damp living conditions which tend to harbour molds. Initial symptoms include, inter alia, a chronic cough, intermittent nasal discharge, either mucoid (mucus) or mucopurlent (mucus and pus), laboured breathing which can lead to “hypertrophy” (increased size) of the oblique muscles thereby causing a “heave line”, ultimately increasing the animals likelihood of becoming exercise intolerant. It is imperative that COPD be treated, because, if left untreated or undetected, COPD can result in severe respiratory distress and even death. As such, it is a condition that must be managed even during the absence of symptoms.

There are two, inter alia, courses of action that one may implement in monitoring the health of their horses, although they are not necessarily mutually exclusive, namely the reactive and the proactive approach. One course of action, that is typically reactive when selected, is to treat the animal using pharmaceuticals. For example, systemic (injectable or oral) antihistamines, bronchodilators, and/or even corticosteroids may be given to the animal, however, corticosteroids if used regularly, increase the likelihood of laminitis, and weakens the animals' immune system. A second approach, the non-pharmacological approach, which is typically reactively selected at first, but later maintained as a proactive course of action, is to minimize if not eliminate the horse's exposure to such conditions, which is to either remove the horse from the problem and/or remove the problem from the horse. However, there is an absence in the prior publications of providing a novel device providing an improved hygiene device for preparing animal feed as set forth hereinbelow.

### SUMMARY OF THE INVENTION

In light thereof, an object of the present disclosure is to provide a feed preparation device comprising: a plurality of containers, each container having shape comprising a wall and a base cooperatively connected thereto, each container being configured and dimensioned to be at least partially insertable together; wherein a first container having at least one opening therein, wherein the location of said at least one opening is positioned in a location selected from the group consisting of: a wall, and a base; and a second container having means for receiving and positioning said first container in a plurality of positions; said second container being configured and dimensioned to hold a liquid substantially comprised of water.

It is another objection of the present disclosure to provide a feed preparation device comprising: a plurality of containers, each container having shape comprising a wall and a base cooperatively connected thereto, each container being configured and dimensioned to be at least partially insertable together, wherein a first container having at lease one opening therein, wherein the location of said at least one opening is positioned in a location selected from the group consisting of: a wall, and a base; and a second container having means for receiving and positioning said first container in a plurality of positions; said second container being configured and dimensioned to hold a liquid, and optionally, having a heating means operatively affixed therewith.

Accordingly, it would be beneficial therefore to provide a novel feed preparation device which is of relatively noncomplex construction, inexpensive to manufacture, and easy to use. Other objectives, advantages, and novel features of the present invention will become more apparent from the following detailed description when taken in conjunction with the accompanying drawings.

### BRIEF DESCRIPTION OF THE DRAWINGS

The following drawings, in which like reference characters indicate like parts, are provided for illustration of the invention and are not intended to limit the invention in any manner whatsoever.

FIG. 1 is a front view of one type of container of a preferred embodiment of the present invention;

FIG. 2 is a front view of second type of container of a preferred embodiment of the present invention;

FIG. 3 is a side view of a second type of container of a preferred embodiment of the present invention;

FIG. 4 is a bottom view of a second type of container a preferred embodiment of the present invention;

FIG. 5 is a front view of a preferred embodiment of the present invention, exhibiting a first position of insertability of the containers;

FIG. 6 is a front view of a second type of container a preferred embodiment of the present invention; exhibiting a second position of insertability of the containers; namely the insertability of the second container with the first type;

FIG. 7 is a top view of FIG. 6;

FIG. 8 is a side view of a preferred embodiment illustrating a drain position of the first container, stabilizing means and cover means; and

FIG. 9 is a side view of a preferred embodiment illustrating a heating means.

### DETAILED DESCRIPTION OF THE INVENTION

The following descriptions of the preferred embodiments are presented to illustrate the present invention and are not to be construed to limit the claims in any manner whatsoever.

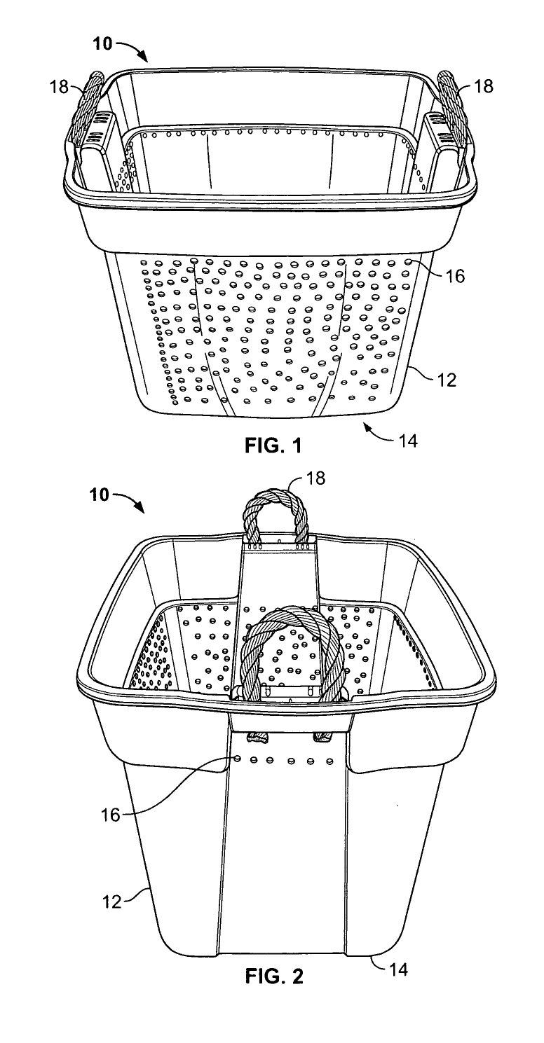

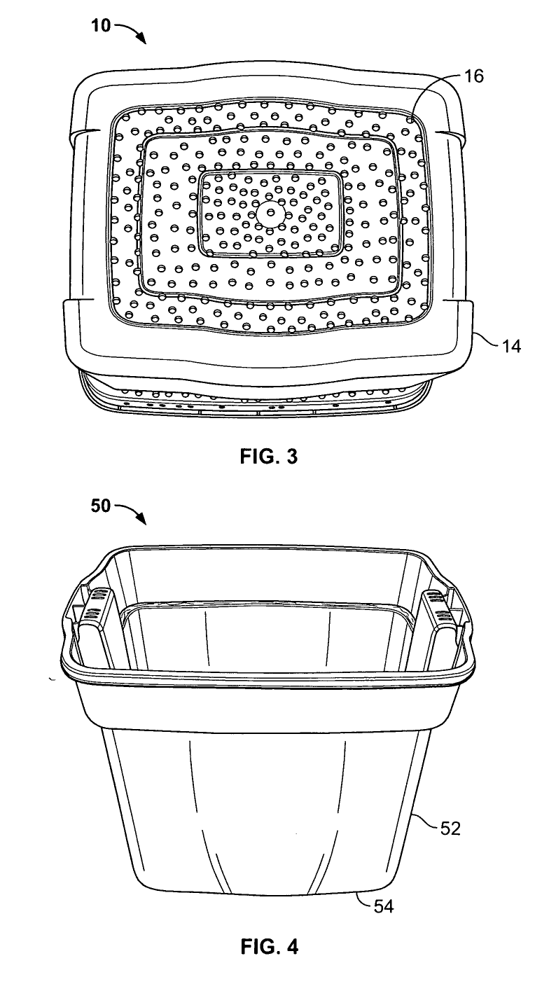

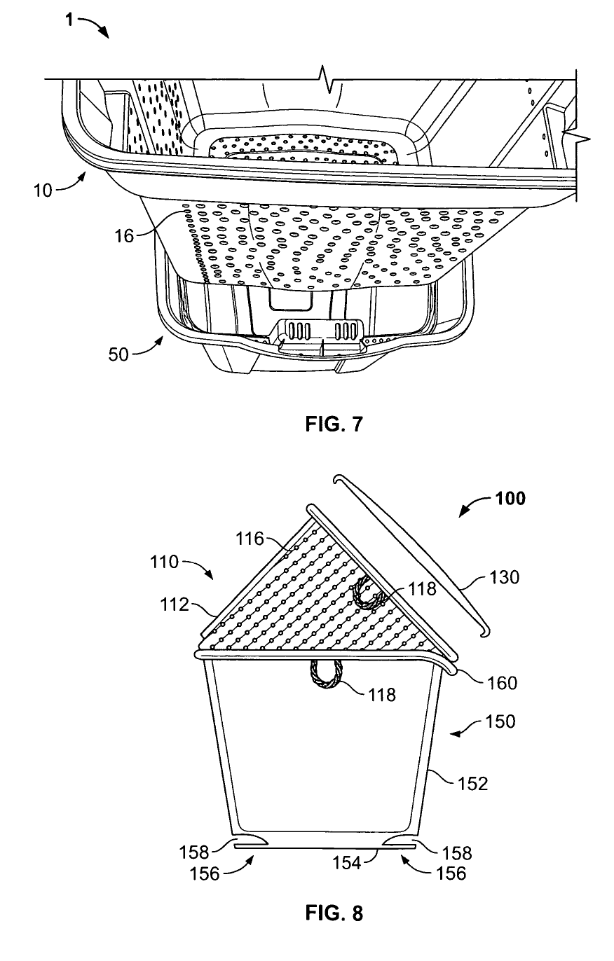

Referring generally to drawings, FIGS. 1 to 7 wherein like reference numerals identify similar structural elements of the device set forth herein. FIGS. 1 to 7 illustrate a feed preparation device 1 comprising: a plurality of containers, each container 10, 50 having shape comprising a wall 12, 52 and a base 14, 54 cooperatively connected thereto. Although FIGS. 1 to 7 depict a shape that is substantially rectangular in nature, it is envisioned that the shape may be any type of polygon. Each container 10, 50 is made from material having the characteristics of lightweight, plastic, and non-porous, although it is envisioned that materials other than plastic may be used. Each container 10, 50 is made from a material having the characteristics of lightweight, plastic, and non-porous, although it is envisioned that materials other than plastic may be used. Each container 10, 50 being configured and dimensioned to be at least partially insertable together.

The first container 10 having a volume with an upper limit of about one (1) bail of hay, although it is preferred to have a volume in the range of about one to fifty gallons, most preferably in the range of about fifteen to thirty gallons. The first container 10 further having at least one opening 16 therein, wherein each opening 16 is configured and dimensioned to permit egress of a liquid, for example, water. The size of each opening 16 is largely dependent on the desired rate of egress of a liquid there through, other factors included in the desired rate of egress include the quantity of opening(s) 16, the position of the opening(s) 16, and the volume of liquid to egress there through 16. Although it is preferred that the at least one opening 16 be configured and dimensioned to be at least three-sixteenths of an inch ( 3/16″), and more preferably at least three-eighths of an inch (⅜″). Moreover, the location of each opening 16 is positioned in a location selected from the group consisting of: a wall 12, and a base 14, however, it is more desirable to locate the opening 16 nearer to the base 14 if located on the wall 12. The first container 10 may optionally include means for handling 18, for example, one or more handles may be incorporated, or a continuous rim with an infinite number of places for an operator to grip.

The second container 50 having means for receiving and positioning said first container 10 in a plurality of positions, said second container 50 being configured and dimensioned to hold a liquid substantially comprised of water (not shown).

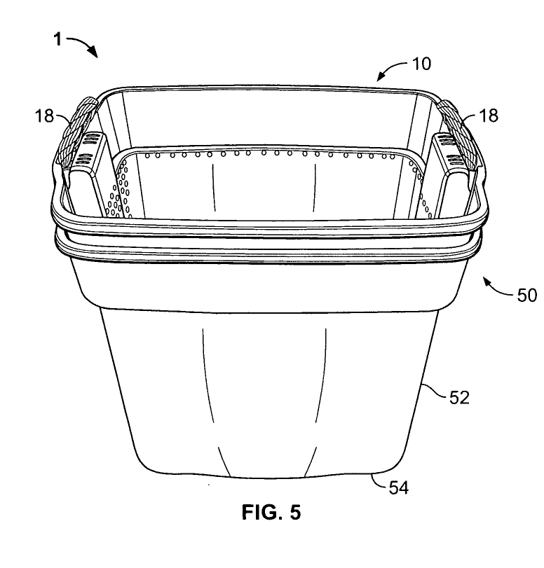

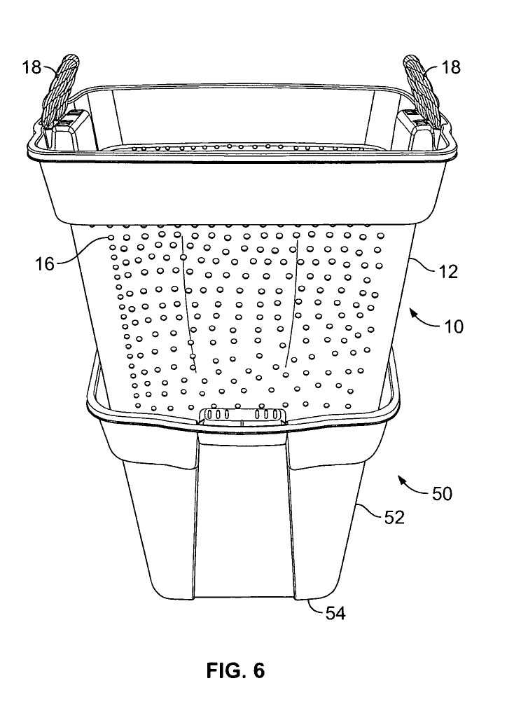

In a preferred embodiment, the second container 150 may optionally further include means for stabilizing 156 said container 150 during positioning of said first container 110 therein, shown in FIG. 8. For example, the stabilizing means 156 may optionally include a plurality of openings 158 located substantially about the base 154, each opening 158 configured and dimensioned to permit access of a human foot. Moreover, the stabilizing means 156 may optionally include a flange (not shown) positioned substantially about said base 154. For example, the stabilizing means 156 may be internal to the wall 152 as in FIG. 8, external to the wall 152 (not shown), or in combination thereof (also not shown). The stabilizing means provides a method a keeping the second container 150 substantially on the surface it is resting upon (e.g., the ground), when the first container 110 is repositioned by the operation(s). For example, when the first container 110 is moved from the submerged position as illustrated in FIG. 5 to the drain position as illustrated in FIG. 6 through FIG. 8.

Additional options for said second container 50, 150, 250 include a transport means, wherein the applicable design is a function of the terrain and weather factors where the feed preparation device 1, 100, 200 is implemented. Particularly, the transport means is selected from the group consisting of: a roller, a wheel, and a ski. For example, wheels (not shown) may be incorporated in the base 54, 154, 254 for transporting and/or positioning the feed preparation device 1, 100, 200.

A further option that may be incorporated into the feed preparation device 100 is a draining means 160, wherein said second container 150 includes a draining means 160 selected from the group consisting of: a ball valve, spout, and a stopcock. Depending on the size of the second container 150, and the volume of liquid therein (i.e., the weight), the inclusion of a draining means 160 would assist the operator(s) in changing and/or draining the liquid therefrom. For example, a ball valve or a stopcock may be incorporated near the base 154, or a spout may be incorporated about the rim of the second container 150 as illustrated in FIG. 8.

In a preferred embodiment illustrated in FIG. 8, a cover or splashguard 130 may be optionally included so as minimize if not eliminate the operator(s) from getting wet. Furthermore, the first container 110 is positioned transverse to the second container 150 wherein the egress of the liquid is completed. Once drained for the desired period, the hay may be removed from the first container 110.

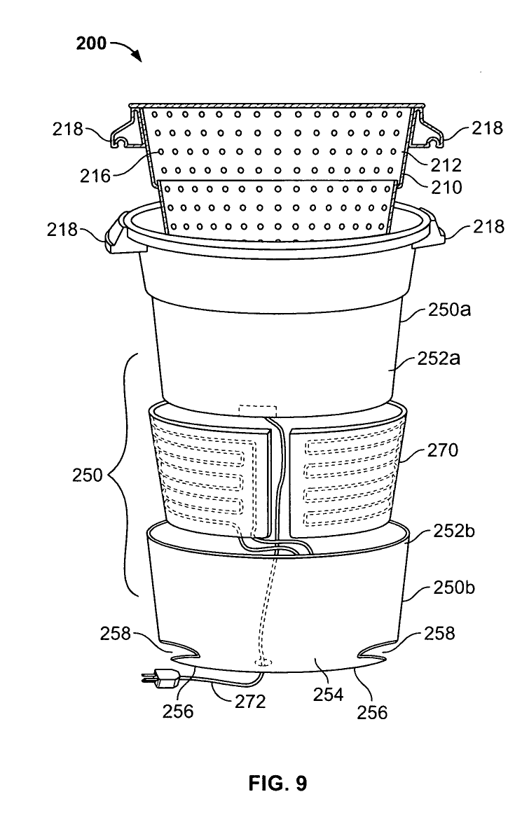

In another preferred embodiment, a still further option that may be incorporated into the feed preparation device 200 is a heating means 270 as illustrated in FIG. 9. Such heating means 270 may be formed integrally with said second container 250. Once again, the need for inclusion of such heating means is dependent on the climate of implementation. For example, the second container 250 comprises an upper portion 250a and a lower portion 250b, wherein the heating means 270 is positioned about the outer wall 252a of the upper portion 250a and inside the outer wall 252b lower portion 250b, such that when the upper portion 250a is inserted through heating means 270 and further into lower portion 250b a substantially tight seal is formed between the upper and lower portions 250a, 150b. Wherefrom the heating means 270 may include a cord passing 272 through the outer wall 252b for connection to a power supply. It is envisioned that the heating means 270 include an automatic feature having set points for temperature control and to prevent overheating (not shown).

In order to better understand the present disclosure, an example of the subject disclosure in use is the following. A first container 10 is placed into a second container 50, and a desired amount of hay from a bale is placed into the first container 10. It should be noted that hay bales have traditionally come in various common sizes, small hale bales traditionally have, inter alia, the following sizes: (a) fourteen (14) inch by sixteen (16) inch by three (3) or four (4) feet long; (b) sixteen (16) inch by eighteen (18) inch by three (3) or four (4) feet long; and (c) sixteen (16) inch by twenty-four (24) inch by four (4) feet long. Additionally, more recently larger hay bales have been produced typically eight (8) feet in length and having cross sections of: (a) two (2) by three (3) feet; (b) three (3) by four (4) feet; and (c) four (4) by four (4) feet. A rinsing liquid, such as water or a water based liquid, is added to the first container 10 until a predetermined volume is achieved, preferably until the hay is substantially submerged, and let soak for a predetermined period of time. The first container 10 is lifted and reposition by the handling means 18, which may either be formed integrally with the first container 10 or may be a rope, such that the first container 10 is substantially removed from the second container 50 thereby permitting egress of the liquid through the opening(s) 16.

In a preferred embodiment illustrated in FIG. 8, a cover or splashguard 130 may be optionally included so as minimize if not eliminate the operator(s) from getting wet. Furthermore, the first container 110 is positioned transverse to the second container 150 wherein the egress of the liquid is completed. Once drained for the desired period, the hay may be removed from the first container 110.

Moreover, all of the above referenced patents; patent applications and publications are hereby incorporated by reference. Many variations of the present invention will suggest themselves to those of ordinary skill in the art in light of the above detailed description. Furthermore, the described embodiments of the present invention are intended to be illustrative rather than restrictive, and are not intended to represent every embodiment of the present invention. All such obvious modifications are within the full-intended spirit and scope of the claims of the present application, wherein such modifications and variations can be made without departing from the spirit or scope of the invention as set forth in the claims herein below both literally and in equivalents recognized in law.

1. A feed preparation device comprising:
a plurality of containers, each container having shape comprising a wall and a base cooperatively connected thereto, each container being configured and dimensioned to be at least partially insertable together; wherein a first container having at least one opening therein, wherein the location of said at least one opening is positioned in a location selected from the group consisting of: a wall, and a base; and
a second container having means for receiving and positioning said first container in a plurality of positions; said second container being configured and dimensioned to hold a liquid substantially comprised of water.

2. A feed preparation device as in claim 1, wherein said containers are made from a material having characteristics selected from the group consisting of: lightweight, plastic, and non-porous.

3. A feed preparation device as in claim 1, wherein said first container has volume with an upper limit of about one (1) bail of hay.

4. A feed preparation device as in claim 1, wherein said first container further includes means for handling.

5. A feed preparation device as in claim 1, wherein said second container further includes means for stabilizing said container during positioning of said first container therein.

6. A feed preparation device as in claim 5, wherein said stabilizing means optionally includes a plurality of openings located substantially about the base, each opening configured and dimensioned to permit access of a human foot.

7. A feed preparation device as in claim 5, wherein said stabilizing means optionally includes a flange positioned substantially about said base.

8. A feed preparation device as in claim 1, wherein said at least one opening is configured and dimensioned to permit egress substantially limited to the liquid.

9. A feed preparation device as in claim 1, wherein said second container further includes a transport means.

10. A feed preparation device as in claim 9, wherein said transport means is selected from the group consisting of: a roller, a wheel, and a ski.

11. A feed preparation device as in claim 1, wherein said second container includes a draining means.

12. A feed preparation device as in claim 11, wherein said draining means is selected from the group consisting of: a ball valve, spout, and a stopcock.

13. A feed preparation device as in claim 1, wherein said first container optionally includes a cover means.

14. A feed preparation device as in claim 1, further comprising a heating means formed integrally with said second container.

15. A feed preparation device comprising:
a plurality of containers, each container having shape comprising a wall and a base cooperatively connected thereto, each container being configured and dimensioned to be at least partially insertable together; wherein a first container having at least one opening therein, wherein the location of said at least one opening is positioned in a location selected from the group consisting of: a wall, and a base; and
a second container having means for receiving and positioning said first container in a plurality of positions; said second container being configured and dimensioned to hold a liquid, and optionally, having a heating means operatively affixed therewith.

16. A feed preparation device as in claim 15, wherein said at least one opening is configured and dimensioned to permit egress substantially limited to the liquid.

17. A feed preparation device as in claim 15, wherein said second container further includes means for stabilizing said container during positioning of said first container therein.

18. A feed preparation device as in claim 15, wherein said stabilizing means optionally includes a member selected from the group consisting of: (a) a plurality of openings, and (b) a flange wherein said member is located substantially about said base and is configured and dimensioned to permit access of a human foot.

19. A feed preparation device as in claim 15, wherein said first container further includes means for handling.

20. A feed preparation device as in claim 19, wherein said handling means includes a pair of handles operatively formed about the upper portion of said container.
